(19) United States
(12) Patent Application Publication
(10) Pub. No.: US 2021/0132246 A1
(43) Pub. Date: May 6, 2021

(54) METHOD FOR DETERMINING A GRID CELL SIZE IN GEOMECHANICAL MODELING OF FRACTURED RESERVOIRS

(71) Applicant: China University of Petroleum (East China), Qingdao (CN)

(72) Inventors: Jingshou LIU, Qingdao (CN); Kongyou WU, Qingdao (CN); Caiwei FAN, Qingdao (CN); Guanjie ZHANG, Qingdao (CN); Lijie CUI, Qingdao (CN); Shouzheng SHENG, Qingdao (CN)

(21) Appl. No.: 17/022,802

(22) Filed: Sep. 16, 2020

(30) Foreign Application Priority Data
Nov. 4, 2019 (CN) 201911062849.0

(51) Int. Cl. G01V 1/28

(52) U.S. Cl. CPC G01V 1/282; G01V 2210/626; G01V 2210/6242; G01V 2210/646

(57) ABSTRACT

A method for determining grid cell size in geomechanical modeling of fractured reservoirs including a variation range of mechanical parameters of the reservoir is determined. A three-dimensional fracture discrete network model is established. Mechanical parameters of fracture surface are determined on the basis of fracture surface mechanical test. Equivalent mechanical parameters of models with different sizes are researched by three-cycle method, and size effect and the anisotropy of the mechanical parameters of the fractured reservoir are calculated respectively, and an optimal grid cell size in geomechanical modeling is determined.

### TECHNICAL FIELD

The disclosure relates to the field of exploration and development of oil and gas field, in particular to a method for determining a grid cell size in geomechanical modeling of fractured reservoirs.

### BACKGROUND ART

Rock mechanical parameters including a rock Poisson's ratio, a rock strength parameter, various elastic modulus, an internal friction angle, cohesion and the like are important basic data for simulating palaeotectonic stress field, simulating in situ stress, predicting dynamic and static fracture parameters, researching on water injection pressures of a reservoir and the like. In grid cells division process during geomechanical modeling, how to determine a cell size is often a problem which is easy to be ignored by researchers. The grid cell size is transitionally determined according to requirements in the exploration and development or software and hardware conditions of a computer, but there often lacks systematic and scientific analysis on whether the grid cell size is reasonable or not. In geomechanical modeling, if the size of a grid cell is too small, the grid cell cannot truly reflect a size of mechanical parameters at a corresponding position; and if the size of the grid cell is too big, on the one hand a precision of a numerical simulation performed later is influenced, and on the other hand, differences between adjacent grid cells are small, reducing practicality of numerical simulation. Different from an intact rock mass, mechanical properties of the fractured reservoir exhibits obvious size effect and anisotropy. The size effect is a phenomenon that the mechanical properties of the rock mass at a certain point changes with different model sizes, and a minimum simulation cell enabling changes of the mechanical parameters of the rock mass to tend to be stable is called as a representative elementary volume (REV). The numerical experiment method is an effective method for researching the size effect and anisotropy of the mechanical parameters of the fractured reservoir at present.

### SUMMARY

The disclosure intents to solve the above problems and provides a method for determining a grid cell size in geomechanical modeling of fractured reservoirs, which can determine an optimal grid cell size in geomechanical modeling of the fractured reservoirs.

The technical scheme of the disclosure is as follows. The method for determining the grid cell size in geomechanical modeling of the fractured reservoirs comprises following specific steps.

Step 1: Calculating Dynamic and Static Mechanical Parameters of Rock and Determining a Variation Range of the Mechanical Parameters of the Reservoir

A representative rock core is selected, and the rock core is processed into a rock with a flat end surface, a diameter of 2.5 cm and a length of 5.0 cm by equipments such as a drilling machine, a slicing machine. A test is performed according to the “Standard for test methods of engineering rock mass (GB/T50266-99)”. In a process of a triaxial compression test, a rock is first placed in a high-pressure chamber, and different confining pressures are applied around the rock so that a vertical stress of the rock is gradually increased. Then, axial and radial strain values of the rock are respectively recorded, and a corresponding stress-strain curve of the rock is obtained. Next, static mechanical parameters of the rock are calculated. The rock triaxial mechanical test may directly simulates an underground real three-dimensional stress environment, and a measurement precision thereof is high, but the rock triaxial mechanical test is hard to reflect the variation ranges of the mechanical parameters of the reservoir under influences of the number and the size of sampling spots. A continuity of the rock mechanical parameters in the vertical direction can be fully considered by utilizing logging information to calculate the dynamic mechanical parameters of the rock, and the relevant formula is as follows:

$$\begin{matrix}{E}_{d} = \frac{{ρ}_{b}}{Δ {t}_{s}^{2}} \cdot \frac{3 Δ {t}_{s}^{2} - 4 Δ {t}_{p}^{2}}{Δ {t}_{s}^{2} - Δ {t}_{p}^{2}} & ( 1 ) \\ {μ}_{d} = \frac{Δ {t}_{s}^{2} - 2 Δ {t}_{p}^{2}}{2 ( Δ {t}_{s}^{2} - Δ {t}_{p}^{2} )} & ( 2 ) \\ φ = 90 - \frac{360}{π} arctan ( \frac{1}{\sqrt{4.73 - 0.098 Φ}} ) & ( 3 )\end{matrix}$$

In the formulas (1) to (3), E_{d} is a dynamic Young's modulus of the rock, with a unit MPa; Pd is dynamic Poisson's ratio of the rock, and is dimensionless; ρ_{b} is a density of the rock in logging interpretation, with a unit of kg/m³; Δtₚ is a longitudinal wave time difference of the rock, with a unit of μs/ft; Δtₛ is a transversal wave time difference of the rock, with a unit of μs/ft; φ is a internal friction angle of the rock, is determined by the triaxial mechanical test of the rock, and is in a unit of °; Φ is a porosity in the logging interpretation, with a unit of %.

Through calibrations of dynamic mechanical parameter results obtained from the rock mechanical tests and logging interpretation, a dynamic-static mechanical parameter conversion model for the rock is established, and a distribution frequency of static rock mechanical parameters in a researched area is determined, and ranges of rock mechanical parameters for a later stress-strain simulation is determined.

Step 2: Observing and Counting Field Fractures and Establishing a Three-Dimensional Fracture Discrete Network Model

Through field observation, an information of the fracture about occurrence, density and combination mode is gathered, to establish a three-dimensional fracture network model and in turn a non-penetrating fracture model by a finite element software, and the three-dimensional fracture network model is imported into a discrete element software so that a research on the size effect and anisotropy of the mechanical parameters of the complex fractured reservoir can be performed based on a three-dimensional discrete element method.

Step 3: Determining Mechanical Parameters of a Surface of the Fracture by the Mechanical Test on the Fracture Surface

A normal stress-normal displacement relation curve of the fracture surface is obtained through a rock mechanical test on a rock with fractures. and a normal stress-normal displacement mathematical relation model of the fracture surface is established. The mathematical relation model is embedded into a source program for numerical simulation through computer programming, by using a mathematical function among a normal stiffness coefficient, a shear stiffness coefficient and a normal stress of the fracture surface. The program embedded with the model is set so that mechanics parameters of fracture surface corresponding to different normal stress conditions are adjusted in n steps in each simulation, and values of the normal stiffness and the shear stiffness of the fracture surface are adjusted automatically, enabling deformation characteristics of the fracture surface to be described by adopting a self-defined fracture surface deformation constitutive model in the stress-strain numerical simulation of the fractured reservoir. In order to improve the simulation precision, the parameter n is set to satisfy the expression n 10.

Step 4: A Three-Cycle Calculation Method of Equivalent Rock Mechanical Parameters

In order to systematically and comprehensively research multi-size mechanical behaviors of the fractured reservoir, and fully utilize a existing three-dimensional fracture discrete element network model information, equivalent mechanical parameters of the models with different sizes are researched by three-cycle method, and systematically analyze the size effect of the mechanical parameters of the fractured reservoir. By means of computer programming, in combination with simulated stress and strain data, the mechanical parameters of a corresponding rock mass is sequentially calculated through the three-cycle method which is specifically implemented by: (1) a position cycle, determining a moving step length in the fracture discrete element model to realize differential simulation of mechanical parameters at different positions with a single size; (2) a size cycle, changing a side length of simulation cells and performing the position cycle again, wherein central coordinates of the simulation cells at the same position are the same; (3) an orientation cycle, changing orientation of the side of the simulation cell to carry out orientation cycle. Thus, equivalent mechanical parameters of models with different sizes, positions and orientations are obtained.

Step 5: Size Effect of Mechanical Parameters of the Fractured Reservoir

Through computer programming, the stress and strain data of simulation cells can be obtained by simulation, and the equivalent rock mechanical parameters distribution in simulation cells with different positions and different sizes are calculated.

Step 6: Anisotropy of Mechanical Parameters of the Fractured Reservoir

Due to different degrees of fracture development in different directions, the mechanical parameters of the reservoir are different in different directions of the simulation cell. Thus, change rules of the rock mechanical parameters in different directions and at different positions are obtained by a three-cycle method.

Step 7: Determining the Optimal Grid Cell Size in Geomechanical Modeling

In order to determine the optimal grid cell size in geomechanical modeling, two evaluation criterions for mechanical parameters are defined:

$$\begin{matrix}{E}_{y} = \frac{1}{n} {\sum }_{i = 1}^{n} \vert {E}_{i} - {E}_{aver} \vert , & ( 4 ) \\ {μ}_{y} = \frac{1}{n} {\sum }_{i = 1}^{n} \vert {μ}_{i} - {μ}_{aver} \vert . & ( 5 )\end{matrix}$$

In formula (4) to formula (5), Ey is a Young's modulus discrimination index, with a unit of GPa; μ_{y} is a Poisson's ratio discrimination index, and is dimensionless; n is the number of the simulation cells at a same size; Eᵢ is an equivalent Young's modulus of the ith simulation cell, with a unit of GPa; μᵢ is a equivalent Poisson's ratio of the ith simulation cell, and is dimensionless; Eₐᵥₑᵣ is an average equivalent Young's modulus of all simulation cells at the same size, with a unit of GPa; μₐᵥₑᵣ is an average equivalent Poisson's ratio of all simulation cells at the same size, and is dimensionless.

According to precision requirements of later stress and strain simulation, thresholds of E_{y} and μ_{y} are set. On the basis of fracture network model established for the area subjected to research, the simulation is performed by changing a size of the model, changing surface density of the fracture in the simulation cell, and ensuring that patterns of the fracture in the simulation cell remains unchanged, so as to obtain E_{y} and μ_{y} values corresponding to different surface densities of the fracture and a grid simulation cell. Reasonable lengths r of sides of the simulation cell corresponding to different fracture surface densities, which is a minimum length of the side of the simulation cell satisfying conditions of E_{y} and μ_{y} being less than respective threshold values, are determined respectively. Then, a minimum value of the reasonable side lengths of the simulation cell under conditions of different fracture surface densities is determined, and a maximum value of the reasonable side lengths of the simulation cells corresponding to the different fracture surface densities is regarded as an optimal grid size in geomechanics modeling.

The beneficial effects of the embodiments are as follows: determining a variation range of the reservoir mechanical parameters through the calculation of dynamic and static mechanical parameters of the rock; establishing a three-dimensional fracture discrete network model through observation of field fractures; determining mechanical parameters of fracture surface on the basis of fracture surface mechanical tests; providing a three-cycle method to research equivalent mechanical parameters of models with different sizes, so as to systematically and comprehensively research the multi-size mechanical behaviors of the fractured reservoir, and fully utilize the existing three-dimensional fractured discrete element network model information; and respectively calculating the size effect and the anisotropy of the mechanical parameters of the fractured reservoir, and finally determining the optimal grid cell size in the geomechanical modeling. The disclosure provides a method for determining the an optimal grid cell size in geomechanical modeling of fractured reservoirs, which has high practical value, low prediction cost and strong operability, and can greatly reduce expenditure of human and financial resources. The prediction result has certain reference significance on multiple aspects such as the geomechanical modeling of the reservoirs, a stress field numerical simulation, the reservoir fracture prediction and an “engineering sweet spots” evaluation.

### BRIEF DESCRIPTION OF THE DRAWINGS

FIG. 1 is a flowchart of a method for determining a grid cell size in geomechanical modeling of fractured reservoirs.

FIG. 2 is a schematic diagram of three-cycle calculation method for equivalent mechanical parameters of models with different sizes wherein black solid line frame represents a fracture discrete element model.

FIG. 3A is a relation between dynamic and static Young's modulus of rock in Chang 6 oil reservoirs in a researched area

FIG. 3B is a relation between dynamic and static Poisson's ratios of rock in Chang 6 oil reservoirs in a researched area.

FIG. 4A is a three-dimensional fracture surface network model built based on a profile of Shigouyi, Ordos basin

FIG. 4B is a three-dimensional fracture discrete element model.

FIG. 5A is equivalent Young's modulus in simulation cells with different sizes and at different positions

FIG. 5B is equivalent Poisson's ratios in simulation cells with different sizes and at different positions. Data points with the same gray level represent the same coordinates of center positions of the simulation cells.

FIGS. 6A-6H show variations of rock Young's modulus and Poisson's ratio in different directions in simulation cells with different sizes and different positions, the data points with the same gray represent the same coordinates of the center positions of the simulation cells.

FIG. 7A is a relation graph between a radius and E_{y} of different simulation cells

FIG. 7B is a relation graph between a radius and μ_{y} of different simulation cells

FIG. 7C is a relation between the fracture surface density and a reasonable radius of the simulation cell; ρ_{A} is a surface density of the fracture.

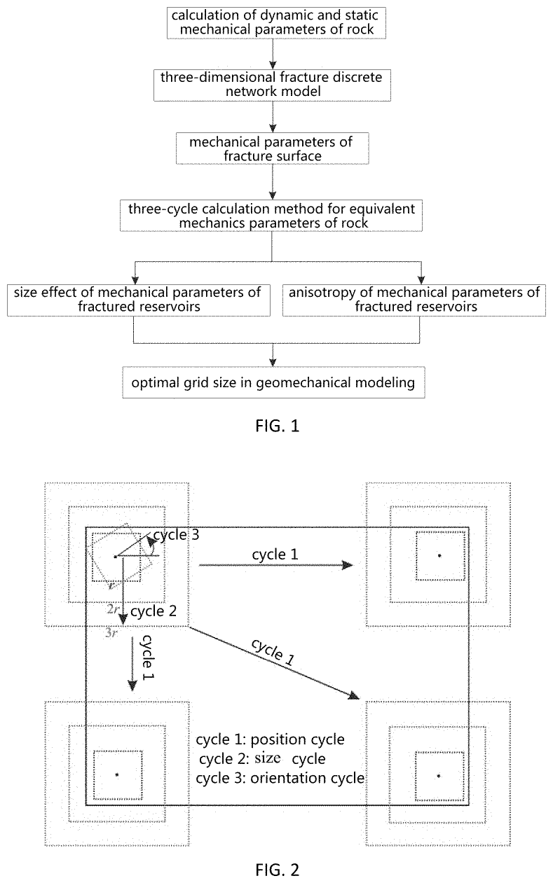

### DETAILED DESCRIPTION OF THE EMBODIMENTS

The specific embodiments of the disclosure are described with reference to the accompanying drawings.

The disclosure takes Chang 6 reservoir in Yanchang formation of the Huaqing area in the Ordos basin of central China as an example to explain specific implementation process of the disclosure. The study area is structurally located in the central and southern Ordos Basin. The Huaqing area is geographically located in Huachi County, Gansu Province, and is a local uplift formed by differential compaction, and further generally is a gentle west-tilted monocline, with a low amplitude nose-like uplift from east to west developed on the monocline background. Folds and faults are relatively undeveloped in the reservoirs of the Ordos Basin, but natural fractures are still widely developed within the reservoir in the basin under the influence of regional tectonic stresses. The current exploration and development practices show that the fractures play a vital role in the exploration and development of oil and gas resources, regardless of a coal reservoir, a tight sandstone reservoir, a shale reservoir or a low-permeability reservoir.

Step 1: Calculating Dynamic and Static Mechanical Parameters of Rock and Determining the Variation Range of Mechanical Parameters of the Reservoir

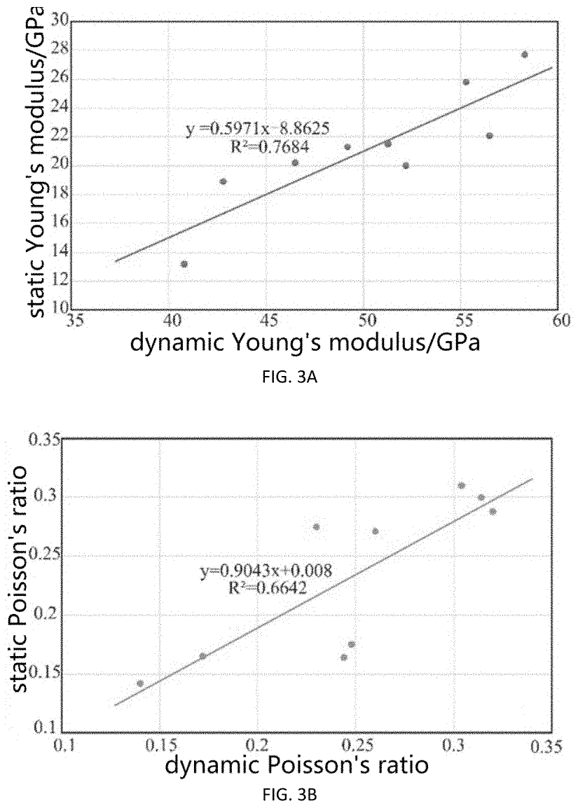

A rock dynamic-static mechanical parameter conversion mathematical model is established through calibration of dynamic mechanical parameter results from rock mechanical tests and logging interpretation (FIGS. 3A and 3B), distribution frequencies of the static rock mechanics parameters in a researched area is determined, to determine ranges of rock mechanics parameters in later stress-strain simulation.

Step 2: Observing and Counting Field Fractures and Establishing a Three-Dimensional Fracture Discrete Network Model

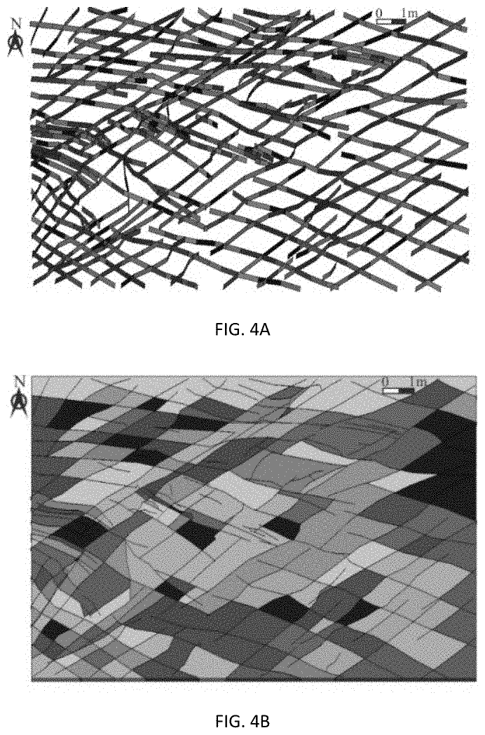

Firstly, through field observation, an information of the fracture about occurrence, density and combination pattern is gathered, to establish a three-dimensional fracture network model (FIG. 4A). A non-penetrating fracture model is established in ANSYS software (FIG. 4B), and is imported into 3DEC software. Then a research is performed on the size effect and anisotropy of the mechanical parameters of the complex fractured reservoir, based on a three-dimensional discrete element method.

Step 3: Performing Fracture Surface Mechanical Tests and Determining Mechanical Parameters of Fracture Surfaces

A normal stress-normal displacement relation curve of the fracture surface is obtained through a rock mechanical test on a rock with fractures, and a normal stress-normal displacement mathematical relation model of the fracture surface is established, wherein a power function model is adopted to reflect the normal stress-normal displacement relation of the fracture surface of Chang 6 reservoirs, and a relation between the normal stress (σₙ) and the normal displacement (Sv) is expressed as follows:

σₙ=1066.7Sᵥ^{1.4548} (6)

A relation between the normal stiffness coefficient (Kₙ) and the normal stress (σₙ) of the fracture surface is expressed as follows:

Kₙ=120.47σₙ^{0.3126} (7)

The test result shows that the normal stiffness of the fracture surface increases with an increase of the normal stress, and they show a relation following a power law. By measuring an amount of shear deformation of the fracture surface corresponding to different normal stresses, a relation expression between the shear stiffness coefficient and the normal stress of the fracture surface is obtained as follows:

Kₛ=104.25σₙ^{0.4812} (8)

By utilizing a mathematical function among a normal stiffness coefficient, a shear stiffness coefficient and normal stress of the fracture surface, the mathematical model is embedded into a source program for numerical simulation by a Fish language. The software is set to adjust respective mechanical parameters of the fracture surface (n=100) under different normal stress conditions on 100 steps in each simulation, then automatically adjust the normal stiffness and the shear stiffness value of the fracture surface, so that deformation characteristics of the fracture surface are described by a self-defined fracture surface deformation constitutive model in numerical simulation of the fractured reservoir.

Step 4: A Three-Cycle Calculation Method of Equivalent Rock Mechanical Parameters

The mechanical parameters of the respective rock masses are sequentially calculated by a three-cycle method, and the Young's modulus of the rock is set to be 27 GPa, the Poisson ratio is set to be 0.25 and the density is set to be 2.5 g/cm³ by combining the distribution ranges of the static mechanical parameters.

Step 5: Size Effect of the Mechanical Parameters of the Fractured Reservoir

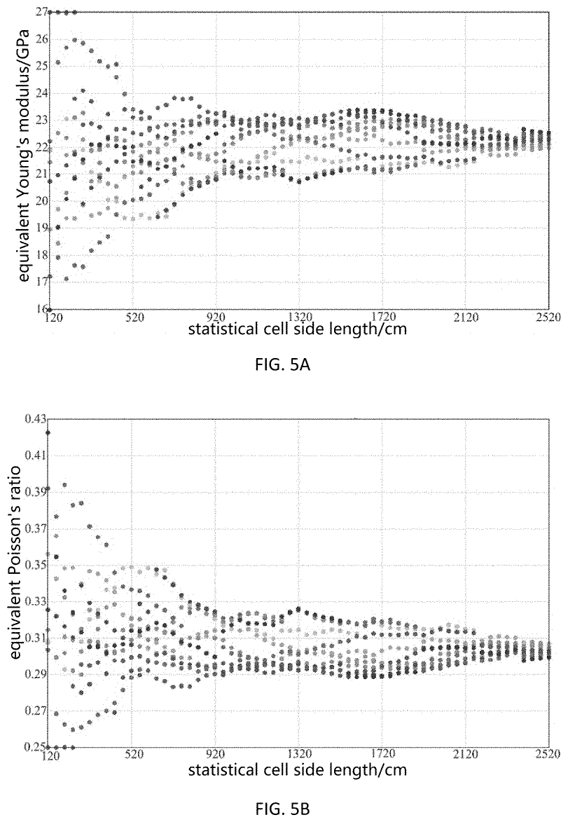

Equivalent mechanical parameters of the simulation cell at different positions, different sizes and different orientations are calculated through secondary development on 3DEC software. The simulation result shows that when a length of a side of the simulation cell is smaller, a fluctuation range of the equivalent Young's modulus and the Poisson's ratio of the simulation cell is larger, and for a same position (data points with a same gray level in the FIGS. 5A and 5B), a difference of the calculated equivalent mechanical parameters with different sizes is larger. As the size of the simulation cell is further increased (more than 2200 cm), the equivalent Young's modulus and the Poisson's ratio at the same position gradually tends to be stable. Therefore, in geomechanical modeling, too small grid cell size make it impossible to completely describe the fracture development pattern in the cell, and therefore, the mechanical parameters at the position cannot be accurately reflected.

Step 6: Anisotropy of Mechanical Parameters of the Fractured Reservoir

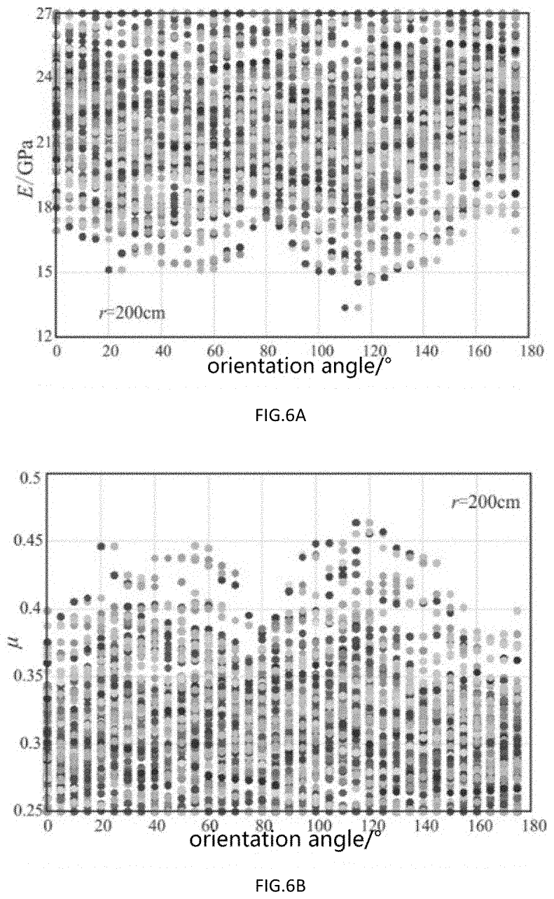

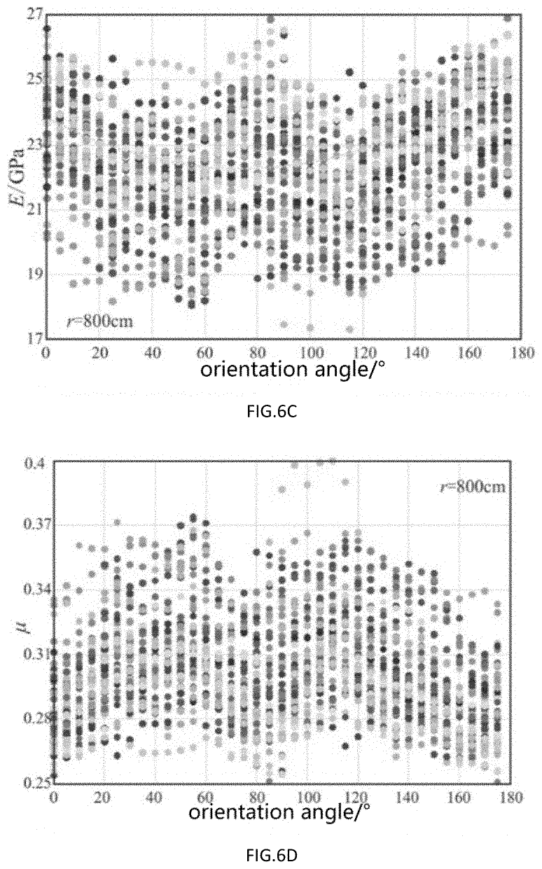

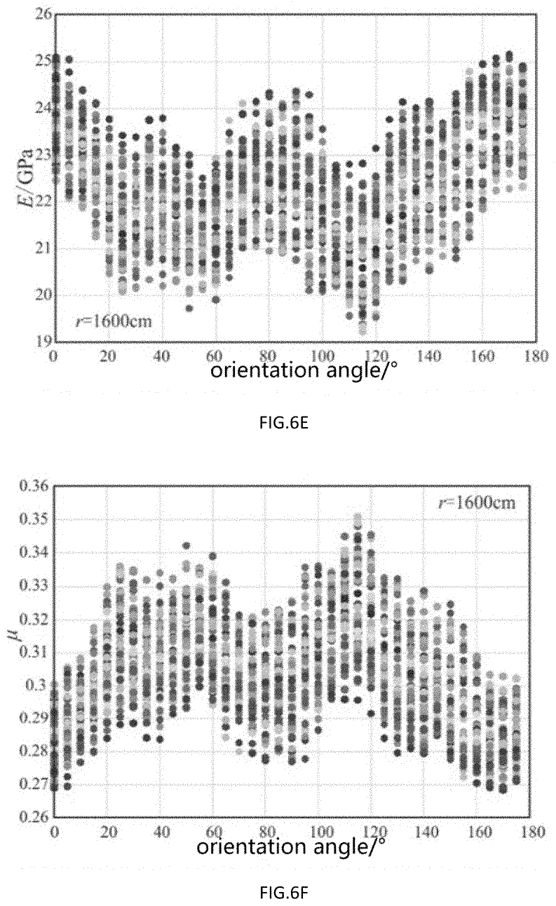

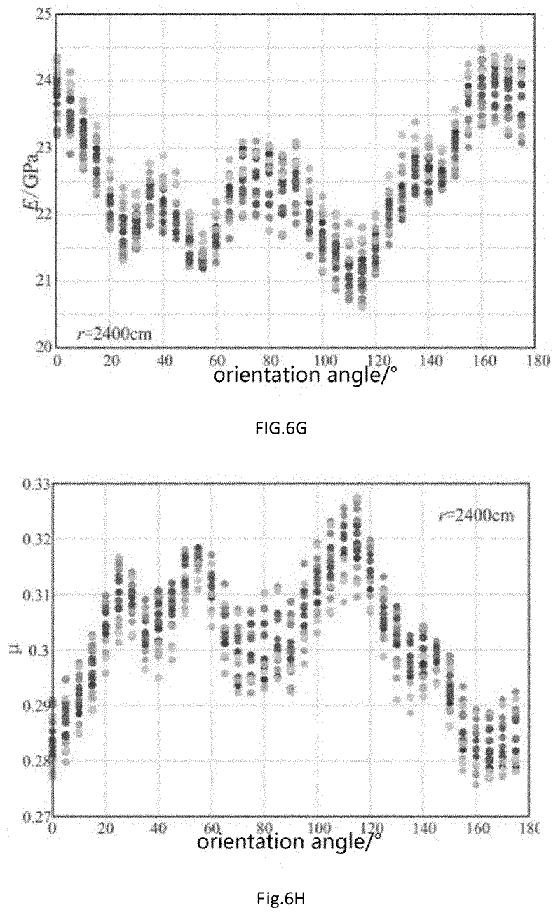

The mechanical parameters of the reservoir are different in different directions of the simulation cell due to the development of fractures. A change rules of the mechanical parameters in different directions and different sizes are calculated respectively through three-cycle calculation. When the size of the simulation cell is small, the anisotropy of the mechanical parameters of the simulation cell is difficult to reflect (FIGS. 6A-6D). With further increase of the simulated cell size (FIGS. 6E and 6F, r=1600 cm), the anisotropy of the simulation cell mechanical parameters gradually becomes clear. The rock Young's modulus in a direction of NE40° −50° and a direction of SEE115° are relatively low values, the rock Young's modulus in a direction of NS and a direction of EW are a high value. A change rule Poisson's ratio is opposite to that of Young's modulus; however, in the same direction, the variation range of the Young's modulus and the Poisson's ratio of the rock is large, that is, the mechanical parameters of the simulation cell at different positions for the size still have great difference from the actual mechanical parameters. When the size of the simulation cell is further increased (FIGS. 6G and 6H, r=2400 cm), the anisotropy of the mechanical parameters of the simulation cell is further clear, and the mechanical parameters of the simulation cell at different positions gradually tend to be consistent, i.e. the simulated mechanical parameters all further approach to the real values.

Step 7: Determining the Optimal Grid Cell Size in Geomechanical Modeling;

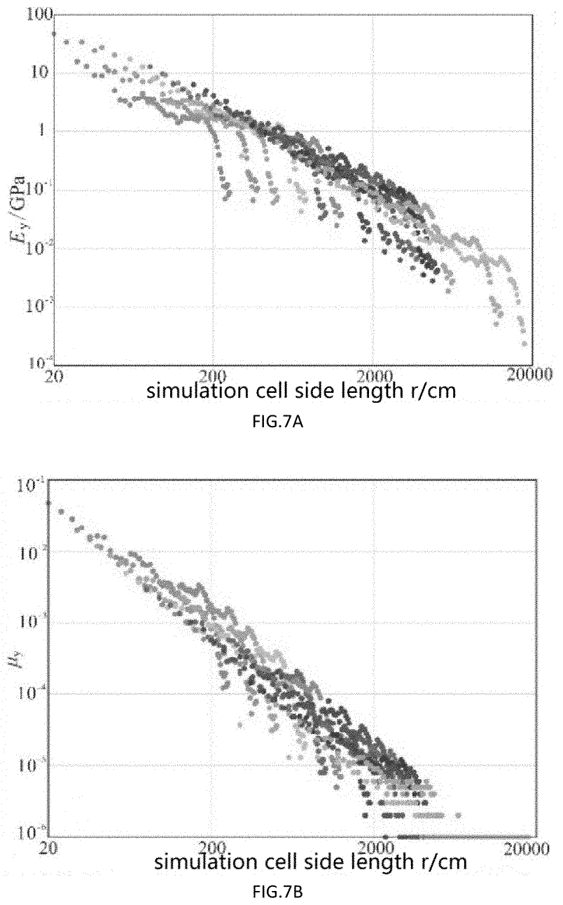

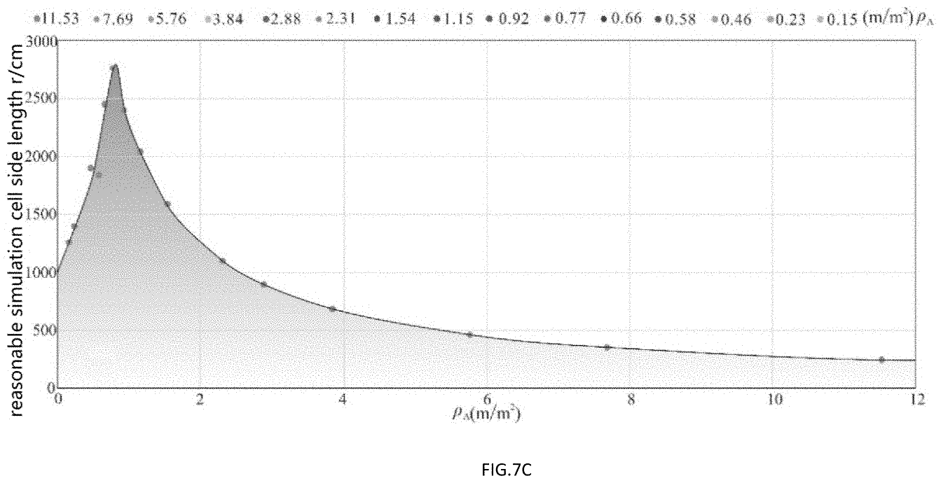

According to precision requirement in the later stress field simulation, the threshold value of E_{y} is set to be 0.01 GPa and the threshold value of μ_{y} is set to be 0.005. By changing the size of the model, changing the surface density of the fractures in the simulation cell, and meanwhile, ensuring that the pattern of the cracks in the simulation cell is unchanged, as shown in FIGS. 7A and 7B, the simulation is performed to obtain the E_{y} and μ_{y} values corresponding to different surface densities of the fractures and the grid simulation cell. According to the graphs shown in the FIGS. 7A and 7B, a reasonable lengths r of the sides of a simulation cell corresponding to different fracture surface densities, which is a minimum length of the side of a simulation cell satisfying conditions of E_{y} being less than 0.01 GPa and μ_{y} being less than 0.005, are determined respectively, thus a graph in FIG. 7C is obtained. In turn, a minimum value of the reasonable side lengths of the simulation cell under conditions of different fracture surface densities is determined. So a maximum value of the reasonable side lengths of the simulation cell corresponding to different fracture surface densities is an optimal grid size in geomechanical modeling, namely the optimal grid cell size in geomechanical modeling is 28 m for the fracture combination pattern in the researched area.

The disclosure has been described above by way of example, but the disclosure is not limited to the above specific embodiments, and any modification or variation made based on the disclosure is within the scope of the disclosure as claimed.

What is claimed is:

1. A method for determining grid cell size in geomechanical modeling of fractured reservoirs, which is implemented by following steps:
step 1 of calculating dynamic and static mechanical parameters of a rock and determining a variation range of mechanical parameters of reservoir;
wherein by a rock triaxial mechanical test, axial and radial strain values of the rock are recorded to obtain a corresponding stress-strain curve of the rock, and the static mechanical parameters of the rock are calculated; on a basis of logging calculation, a dynamic-static mechanical parameters conversion model for the rock is established through a calibration on dynamic mechanical parameter results from a rock mechanical test and logging interpretation, and a distribution frequency of the static mechanical parameters of the rock in a researched area and a interval of the mechanical parameters of the rock in later numerical simulation are determined;
step 2 of observing and counting field fractures and establishing a three-dimensional crack discrete network model;
wherein through a field observation, an information of the fracture about occurrence, density and combination pattern is gathered, to establish a three-dimensional fracture network model and in turn a non-penetrating fracture model in finite element software, and import the three-dimensional fracture network model into a discrete element software, and further perform a research about size effect and anisotropy on the mechanical parameters of the complex fractured reservoir based on a three-dimensional discrete element method.
step 3 of performing a fracture surface mechanical test and determining mechanical parameters of the fracture surface;
wherein a normal stress-normal displacement relation curve of the fracture surface is obtained through a rock mechanics test on the rock with fractures, a normal stress-normal displacement mathematical relation model of the fracture surface is established, the mathematical relation model is embedded into a source program for numerical simulation through computer programming by using a mathematical function among a normal stiffness coefficient, a shear stiffness coefficient and a normal stress of the fracture surface, software with the embedded source program is set to adjust the respective mechanics parameters of the fracture surface under different positive stress conditions in n steps in each simulation, wherein n≥10, and automatically adjust values of the normal stiffness and the shear stiffness of the fracture surface,
step 4 of performing a three-cycle calculation method on equivalent mechanical parameters of the rock;
wherein the three-cycle calculation method is employed to research the equivalent mechanical parameters of the models with different sizes, and systematically analyze a size effect of the mechanical parameters of the fractured reservoir, and by means of computer programming and in combination with simulated stress and strain data, the mechanical parameters of the corresponding rock are calculated sequentially with the three-cycle calculation method which is specifically implemented as follows: \textcircled{1} position cycle, determining a moving step length in a fracture discrete element model to realize a simulation on differences of mechanical parameters at different positions with a single size; \textcircled{2} size cycle, changing a length of a side of a simulation cell and performing the position cycle again with central coordinates of the simulation cells at the same position being the same; \textcircled{3} orientation cycle, changing orientation of the side of the simulation cell to carry out orientation cycle, thus, equivalent mechanical parameters of models with different sizes, positions and orientations are obtained;
step 5 of studying size effect of mechanical parameters of fractured reservoir;
wherein through computer programming, the stress and strain data of simulation cell can be obtained by simulation, and equivalent mechanical parameter distributions of the simulation cell at different positions and with different sizes are calculated respectively;
step 6 of studying anisotropy of mechanical parameters of the fractured reservoir;
wherein due to different development degree of the fracture in different directions, the mechanical parameters of the reservoir are different in different directions of the simulation cell; change rules of the mechanical parameters in different directions and at different positions are calculated respectively by the three-cycle calculation method to obtain a distribution of equivalent mechanical parameters of simulation cells in different positions and with different sizes;
step 7 of determining an optimal grid cell size in geomechanical modeling;
wherein in order to determine the optimal grid cell size in geomechanical modeling, two evaluation criterions of mechanical parameters are defined:
$$\begin{matrix}{E}_{y} = \frac{1}{n} {\sum }_{i = 1}^{n} \vert {E}_{i} - {E}_{aver} \vert & ( 4 ) \\ {μ}_{y} = \frac{1}{n} {\sum }_{i = 1}^{n} \vert {μ}_{i} - {μ}_{aver} \vert & ( 5 )\end{matrix}$$
in formula (4) to formula (5), Ey is a Young's modulus discrimination index, with a unit of GPa; μ_{y} is a Poisson's ratio discrimination index, and is dimensionless; n is a number of the simulation cells at the same size; Eᵢ is an equivalent Young's modulus of the ith simulation cell, with a unit of GPa; μᵢ is an equivalent Poisson's ratio of the ith simulation cell, and is dimensionless; Eₐᵥₑᵣ is an average equivalent Young's modulus of all simulation cells at the size, with a unit of GPa, μₐᵥₑᵣ is an average equivalent Poisson's ratio of all simulation cells at the size, and is dimensionless;
according to precision requirements of later stress and strain simulation, thresholds of E_{y} and μ_{y} are set, and on a basis of the established three-dimensional network model of the fracture, through changing the size of the model, changing a surface density of the fracture in the simulation cell and ensuring that a pattern of the fracture in the simulation cell remains unchanged, the simulate is performed to obtain E_{y} and μ_{y} values corresponding to different surface densities of the fracture and grid simulation cells; reasonable lengths r of the side of the simulation cell corresponding to different fracture surface densities are determined respectively; the reasonable length r of the side of the simulation cell is a minimum length of a side of the simulation cell satisfying that E_{y} and μ_{y} are less than respective threshold values, and in turn a minimum value of the reasonable lengths of the side of the simulation cell with different fracture surface densities is determined, and a maximum value of the reasonable lengths of side of the simulation cell corresponding to different fracture surface densities is regarded as the optimal grid size in geomechanics modeling.
